(19) United States
(12) Patent Application Publication
(10) Pub. No.: US 2019/0354986 A1
(43) Pub. Date: Nov. 21, 2019

(54) DYNAMICALLY GENERATING VERIFICATION VALUES USING ELECTRONIC INK AND POWER DERIVED FROM EXTERNAL SOURCE

(71) Applicant: Bank of America Corporation, Charlotte, NC (US)

(72) Inventors: Ryan Danny Brimhall, New York, NY (US); Steven M. Twombly, Saco, ME (US)

(21) Appl. No.: 15/982,852

(22) Filed: May 17, 2018

(51) Int. Cl. G06Q 20/40; G06Q 20/34

(52) U.S. Cl. CPC G06Q 20/4018; G06Q 20/204; G06Q 20/352; G06Q 20/341

(57) ABSTRACT

Aspects of the disclosure relate to a method for electronic funds transfer including generating a dynamic card verification value using power from a point-of-sale terminal. Aspects of the disclosure also relate to an apparatus, such as a card device, capable of displaying a dynamic card verification value or other card information using an electronic ink display integral to the card device. The card device might not have an integral battery or power source, and thus might only update the card information and refresh the electronic ink display while connected to a point-of-sale terminal or automated teller machine. The electronic ink display may persist in displaying a most recent image (e.g., a most recent dynamic card verification value) while the card device is not connected to power, and update the next time the card device receives power by being connected to a point-of-sale terminal or automated teller machine.

### BACKGROUND

Aspects of the disclosure relate to improving information security protocols for physical tokens, such as payment cards that may be used as data-bearing tokens in electronic transactions.

As organizations increasingly provide methods of electronic funds transfer, security becomes increasingly important. The industry-standard card verification value (CVV) for a credit or debit card, which is used to reduce incidents of unauthorized activity, is typically a series of 3-4 numbers physically embossed or imprinted on either the front or rear of the card. When a static CVV is provided for a card (e.g., printed on the card), once such CVV is obtained in a malicious and/or unauthorized manner, the CVV's integrity as a security feature is reduced until the credit or debit card owner notifies the card's financial institution of the potential issue. A dynamic CVV can, after such a compromising event, protect an account associated with the card simply by changing the CVV value. A dynamic CVV also protects against potential merchant security breaches, as a different CVV may be generated after every transaction made with the card account. There will always be a need for improved information security while also optimizing the efficient and effective technical operations of the devices and computer systems that maintain and provide such information.

### SUMMARY

Aspects of the disclosure provide effective, efficient, scalable, and convenient technical solutions that address and overcome the technical problems associated with dynamic card verification values. For instance, a standard credit or debit card is unable to contain a dynamic display necessary for a dynamic CVV because the card's physical size does not typically permit any meaningful electrical power reserve (via internal battery or otherwise) required by a traditional display (e.g., liquid crystal display). Internal batteries or power sources also introduce an additional layer of technical complexity that makes manufacturing and eventually disposing of powered credit or debit cards even more difficult.

In contrast to a traditional credit or debit card with a static CVV, and in contrast to a credit or debit card with an internal power source, a traditionally-sized credit or debit card may include a small electronic ink display to exhibit a dynamic and automatically changing CVV, for which the card requires no battery or other electrical power reserve during the entirety of its life and/or usage. The card may draw power from point-of-sale terminals or automated teller machines, and use the power from those terminals or machines to generate a new dynamic CVV and refresh the display of the CVV on the electronic ink display.

In accordance with one or more embodiments, a card (e.g., a credit card, a debit card, an automated teller machine card) may include an electronic ink display; an integrated circuit configured to connect to and draw power from a point-of-sale terminal or an automated teller machine; at least one processor; and memory storing computer-readable instructions that, when executed by the at least one processor, cause the card to: determine that the card has connected, via the integrated circuit, to the point-of-sale terminal or the automated teller machine; update a dynamic card verification value for the card to a new dynamic card verification value; and refresh the electronic ink display to display the new dynamic card verification value.

In some embodiments, the processor may use the power from the point-of-sale terminal or the automated teller machine to execute the computer-readable instructions. In some embodiments, the card may use the power from the point-of-sale terminal or the automated teller machine to refresh the electronic ink display.

In some embodiments, the computer-readable instructions, when executed by the at least one processor, may cause the card to: receive, via the point-of-sale terminal or the automated teller machine, new information for display on the electronic ink display of the card; and refresh the electronic ink display of the card to display the new information. In some embodiments, the computer-readable instructions, when executed by the at least one processor, may cause the card to: receive an updated card number for the card; and refresh the electronic ink display of the card to display the updated card number for the card. In some embodiments, the computer-readable instructions, when executed by the at least one processor, may cause the card to: receive an updated expiration date for the card; and refresh the electronic ink display of the card to display the updated expiration date for the card. In some embodiments, the computer-readable instructions, when executed by the at least one processor, may cause the card to: receive an updated name of a person associated with the card; and refresh the electronic ink display of the card to display the updated name of the person associated with the card. In some embodiments, the computer-readable instructions, when executed by the at least one processor, may cause the card to: receive an updated offer associated with the card; and refresh the electronic ink display of the card to display the updated offer associated with the card.

In some embodiments, the integrated circuit may include an EMV (Europay, MasterCard, and Visa) chip. In some embodiments, the EMV chip may be configured according to an International Organization for Standardization and International Electrotechnical Commission (ISO/IEC) 7816 standard.

In some embodiments, the electronic ink display may display a static image until the electronic ink display is refreshed. In some embodiments, the electronic ink display might not require power to display the static image until the electronic ink display is refreshed. In some embodiments, the electronic ink display may be configured to display multiple pieces of information associated with the card. In some embodiments, the card may include a second electronic ink display, and the computer-readable instructions, when executed by the at least one processor, may cause the card to: refresh the second electronic ink display of the card to display updated information different from the new dynamic card verification value.

In some embodiments, the card may include a magnetic strip configured to draw second power from the point-of-sale terminal or the automated teller machine when the magnetic strip is in communication with the point-of-sale terminal or the automated teller machine.

In some embodiments, the card may include a contactless chip configured to draw second power from the point-of-sale terminal or the automated teller machine when the magnetic strip is in communication with the point-of-sale terminal or the automated teller machine.

In some embodiments, the computer-readable instructions, when executed by the at least one processor, may cause the card to: receive a command, via the integrated circuit and from the point-of-sale terminal or the automated teller machine, indicating that the dynamic card verification value for the card should be updated to the new dynamic card verification value; and based on the command, update the dynamic card verification value for the card to the new dynamic card verification value.

In some embodiments, a size of the card may conform to an International Organization for Standardization and International Electrotechnical Commission (ISO/IEC) 7810 ID-1 standard.

In accordance with one or more embodiments, a method may include: at a card comprising an electronic ink display, an integrated circuit, at least one processor, and memory:

draw power to the card from a point-of-sale terminal or an automated teller machine to which the card is connected via the integrated circuit; and using the power from the point-of-sale terminal or the automated teller machine to which the card is connected: update a dynamic card verification value for the card to a new dynamic card verification value; and refresh the electronic ink display to display the new dynamic card verification value.

In accordance with one or more embodiments, a system may include an automated teller machine and a card. The card may include: an electronic ink display; an integrated circuit configured to draw power from the automated teller machine when the card is connected to the automated teller machine; at least one processor; and memory storing executable instructions that, when executed by the at least one processor using the power drawn from the automated teller machine, cause the card to: update a dynamic card verification value for the card to a new dynamic card verification value; and use the power drawn from the automated teller machine to refresh the electronic ink display to display the new dynamic card verification value.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an illustrative back side of a card with an electronic ink display for displaying a dynamic CVV in accordance with one or more example embodiments;

FIG. 2 depicts an illustrative front side of a card with an electronic ink display for displaying a dynamic CVV in accordance with one or more example embodiments;

FIGS. 3A and 3B depict an illustrative back side of a card with an electronic ink display for displaying a dynamic CVV in accordance with one or more example embodiments;

FIGS. 4A and 4B depict an illustrative front side of a card with an electronic ink display for displaying a dynamic CVV in accordance with one or more example embodiments;

FIGS. 5A and 5B depict an illustrative front side of a card with a plurality of electronic ink displays for displaying a dynamic CVV and a card number in accordance with one or more example embodiments;

FIGS. 6A and 6B depict an illustrative front side of a card with an electronic ink display for displaying an expiration date in accordance with one or more example embodiments;

FIGS. 7A and 7B depict an illustrative front side of a card with an electronic ink display for displaying a name in accordance with one or more example embodiments;

FIGS. 8A and 8B depict an illustrative front side of a card with an electronic ink display for displaying one or more offers in accordance with one or more example embodiments;

FIGS. 9A and 9B depict an illustrative front side of a card with a plurality of electronic ink displays for displaying a dynamic CVV, a card number, an expiration date, and one or more offers in accordance with one or more example embodiments;

FIGS. 10A and 10B depict an illustrative front side of a card with an electronic ink display for displaying multiple pieces of card information, such as a card product name, a card number, an expiration date, a dynamic CVV, a card number, an expiration date, and one or more offers in accordance with one or more example embodiments;

FIG. 11 depicts an illustrative computing environment for using a card with an electronic ink display for displaying dynamic information in accordance with one or more example embodiments;

FIG. 12 depicts an illustrative block diagram of a card with an electronic ink display for displaying dynamic information in accordance with one or more example embodiments;

FIG. 13 depicts an illustrative event sequence for using a card with an electronic ink display to display dynamic information in accordance with one or more example embodiments;

FIG. 14 depicts an illustrative event sequence for using a card with an electronic ink display to display dynamic information in accordance with one or more example embodiments;

FIG. 15 depicts an illustrative event sequence for using a card with an electronic ink display to display dynamic information in accordance with one or more example embodiments;

FIG. 16 depicts an illustrative example of a graphical user interface for a security alert related to a card with an electronic ink display for displaying dynamic information in accordance with one or more example embodiments;

FIG. 17 depicts an illustrative example of a graphical user interface for updating a user profile related to a card with an electronic ink display for displaying dynamic information in accordance with one or more example embodiments;

FIG. 18 depicts an illustrative method for using a card with an electronic ink display to display dynamic information in accordance with one or more example embodiments;

FIG. 19A depicts an illustrative building-access card with an electronic ink display for displaying a dynamic security code in accordance with one or more example embodiments; and

FIG. 19B depicts an illustrative example of a graphical user interface for accessing a computing platform using a building-access card with a dynamic security code in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Some aspects of the disclosure relate to a credit or debit card that uses a dynamic card verification value (CVV) by displaying the CVV on the card itself using a slim electronic ink display (e.g., electronic paper display technology). The card may be configured to generate a new CVV automatically upon use at any point-of-sale terminal or automated teller machine. The electronic ink display, which does not require any electrical charge to maintain a static image, will, akin to a traditional credit/debit card, display the current CVV indefinitely. But after inserting the credit/debit card into any point-of-sale terminal or automated teller machine, the credit/debit card will, via the magnetic strip or EMV chip, draft electric charge from the terminal and use the electric charge from the terminal to change the CVV to a new value. For example, the card may draw an electric charge through a chip on the card or a magnetic strip of the card. The card may include a microprocessor and memory, which, following completion of the transaction, will generate a new CVV using an algorithm securely stored in the memory. After generating the new CVV, the card will refresh the electronic ink display to show the new CVV, which will be the only acceptable CVV (and which will remain static until the next time the card is inserted into a point-of-sale receiver or automated teller machine without need for any additional electrical power). In other words, because the card draws power from the point-of-sale receiver, the card does not need a battery and therefore has a longer life and expected duration of use, as well as a lower manufacturing cost, than would be required for a dynamic CVV-enabled card with a built-in battery.

In other embodiments, other aspects of the card could be displayed using electronic ink technology. For example, an account number or expiration date of the card could be displayed using electronic ink technology. This may allow, for example, a new account number or new expiration date of the card to be issued without requiring a new card to be manufactured and sent to the cardholder. Alternatively or additionally, this may allow for enhanced security (e.g., a card holder travelling overseas could activate and display a temporary card number for use and display on the card while on the overseas trip, and restore the display of the permanent account number when returning from the trip).

In another example, a card holder's name could be displayed using electronic ink technology, thereby allowing the card holder's name to be updated (e.g., after marriage or another life event) without needing a new card to be issued. Some updates (e.g., changing account holder name, card number, card expiration date) might only be enabled at a certain type of terminal (e.g., an automated teller machine, but not a standard point-of-sale terminal).

In yet another example, different card information (e.g., promotional information such as quarterly spending bonus categories) could be displayed on the card itself using electronic ink technology, and updated periodically using power drawn from use of the card. As in other example embodiments, the promotional information might only be updated when a particular type of terminal (e.g., an automated teller machine) is used. In some embodiments, rather than a processor on the card performing the processing for determining the updated information, the terminal might receive and transfer the updated information to the card for display on the card using electronic ink. For example, the terminal might receive, from a server, quarterly bonus category spending information that is to be displayed on the card using electronic ink. The card might receive the updated information from the terminal via a chip embedded on the card, and use electricity provided to the card via the chip to update the electronic ink of the card with the newly received information (e.g., updated quarterly bonus category available for the card).

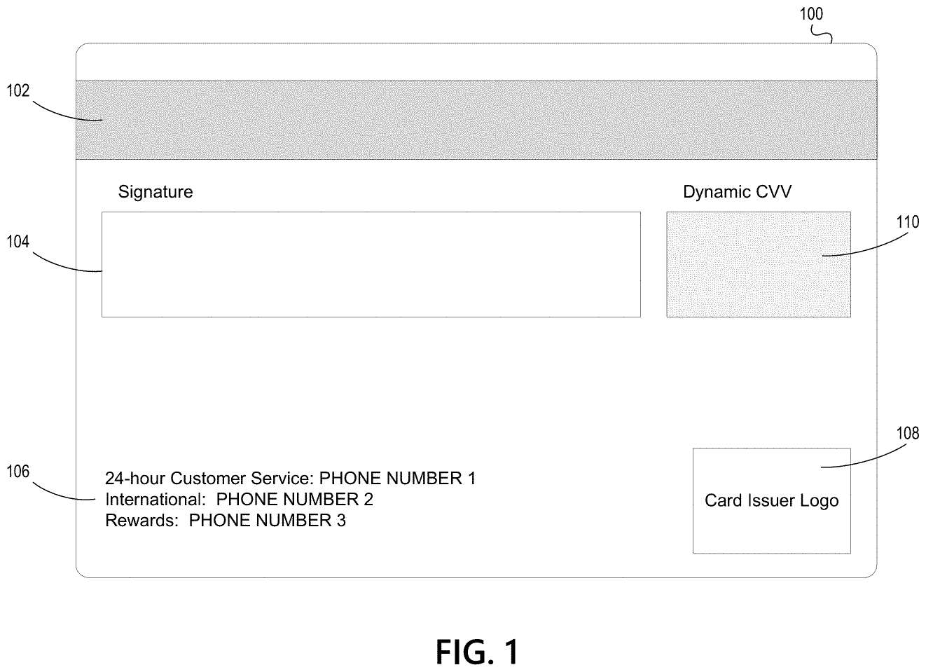

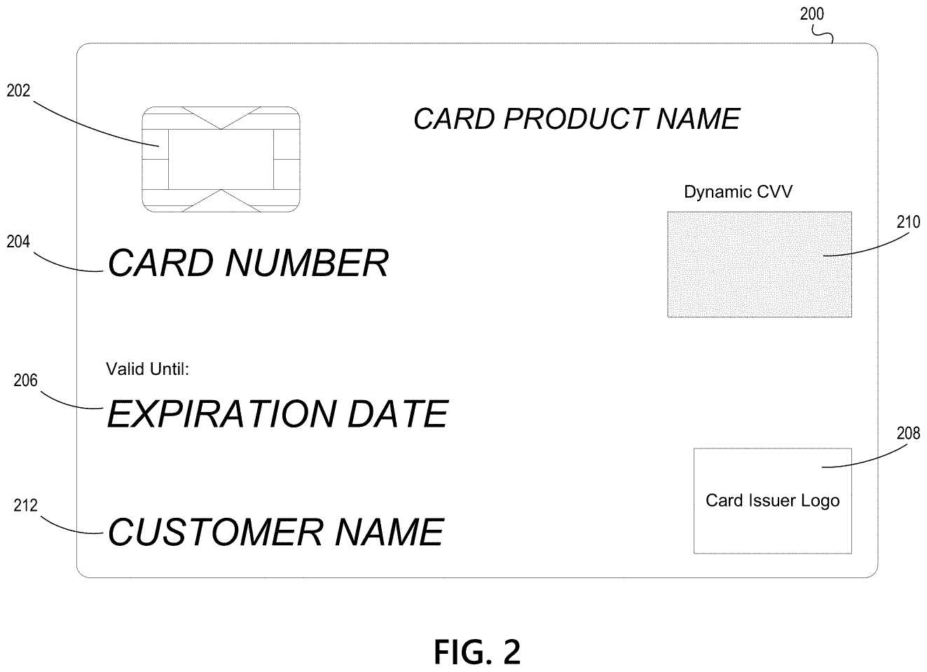

FIGS. 1 and 2 depict illustrative front and back views of one or more cards that may include one or more electronic ink display for displaying a dynamic CVV in accordance with one or more example embodiments. Referring to FIG. 1, which depicts a back of card 100, card 100 may include a magnetic strip 102, a signature panel 104, card information 106 (e.g., support contact information), and card-issuer logo 108. Card 100 may be traditionally sized (e.g., 85.60 mm×53.98 mm (3⅜×2⅛ inches), with rounded corners with a radius of 2.88-3.48 mm, conforming to an International Organization for Standardization and International Electrotechnical Commission (ISO/IEC) standard, such as the ISO/IEC 7810 ID-1 standard).

When card 100 is inserted into an automated teller machine, or swiped through a point-of-sale terminal, card 100 may draw power from the automated teller machine or point-of-sale terminal (e.g., via magnetic strip 102). Card 100 may include one or more capacitors to temporarily store the power drawn from the automated teller machine or point-of sale terminal.

Card 100 may include one or more electronic ink displays (e.g., electronic ink display 110). The one or more electronic ink displays may include, for example, an electronic ink display that uses electronic paper technology.

The one or more electronic ink displays may display one or more pieces of information associated with card 100. For example, the one or more electronic ink displays may display a dynamic CVV associated with card 100, a card number associated with the card, an expiration date associated with the card, a name associated with the card, and/or an offer associated with the card, for example.

When card 100 draws power from an automated teller machine or point-of-sale terminal, card 100 may use the power to refresh the one or more electronic ink displays. Because electronic ink displays do not require continuous power to display an image, and electronic ink displays continue to display the most recent image until the next time the display is refreshed, the one or more electronic ink displays may display a static image until the one or more electronic ink displays are refreshed. The one or more electronic ink displays might not require power to display the static image until the electronic ink display is refreshed. When an electronic ink display is refreshed, the electronic ink display may display new information, the electronic ink display may display information that is the same as previously displayed information, or the electronic ink display may display information that includes both new information and previously displayed information.

FIG. 2 depicts an illustrative front view of a card that may include one or more electronic ink displays. Card 200 may be a same card as card 100 depicted in FIG. 1, or may be a different card from card 100 depicted in FIG. 1. As illustrated in FIG. 2, card 200 may include, for example, a card product name, an integrated circuit (e.g., EMV chip 202), a card number 204, an expiration date 206, a card issuer logo 208, a customer name 212, and/or an electronic ink display 210.

The integrated circuit (e.g., EMV chip 202) may be an EMV chip configured according to an ISO/IEC 7816 standard. In some embodiments, the integrated circuit may include a contactless chip, such as a contactless chip configured according to an ISO/IEC 14443 standard. When card 200 is inserted into an automated teller machine, or inserted into a point-of-sale terminal, card 200 may draw power from the automated teller machine or point-of-sale terminal (e.g., via the integrated circuit). Card 200 may include one or more capacitors to temporarily store the power drawn from the automated teller machine or point-of sale terminal.

Electronic ink display 210 may display a dynamic CVV on the face of card 200. When card 200 draws power from an automated teller machine or point-of-sale terminal, card 200 may use the power to refresh electronic ink display 210. Electronic ink display 210 may display the CVV until the next time electronic ink display 210 is refreshed.

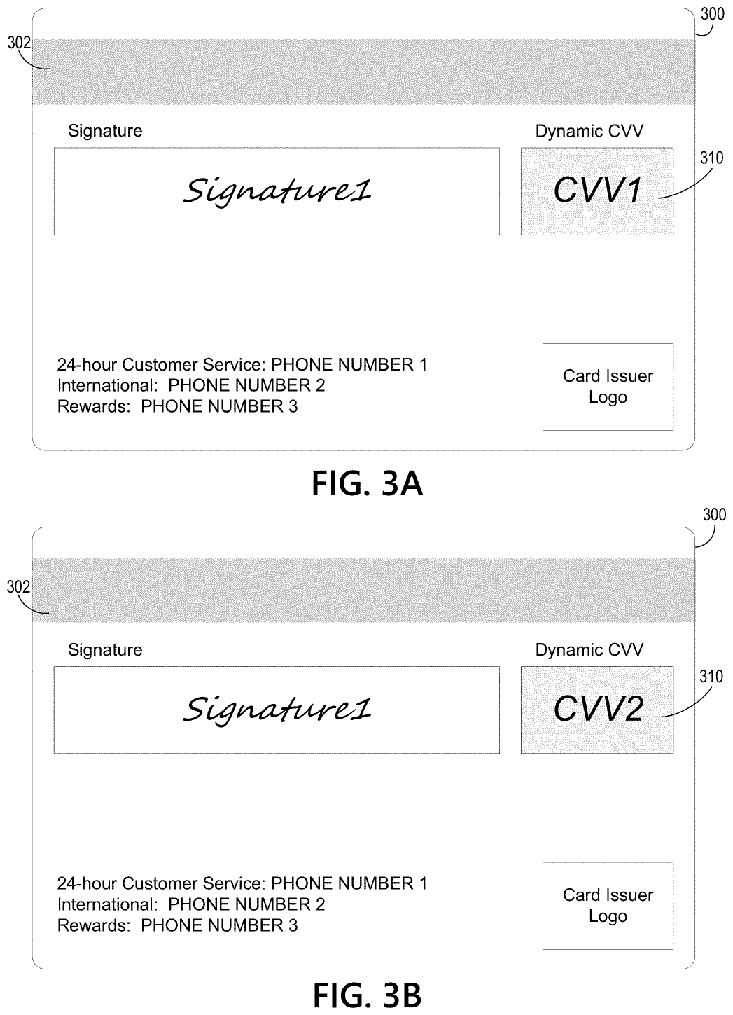

FIGS. 3A and 3B depict illustrative back side views of a card 300 with an electronic ink display (e.g., electronic ink display 310) for displaying a dynamic CVV. As depicted in FIG. 3A, electronic ink display 310 may display a first CVV. When card 300 is used at a point-of-sale terminal or automated teller machine, card 300 may draw power (e.g., via magnetic strip 302) from the point-of-sale terminal or automated teller machine, and use the power to generate a new dynamic CVV and refresh electronic ink display 310. Thus, as depicted in FIG. 3B, electronic ink display 310 may display a second CVV that is different from the first CVV that electronic ink display 310 displayed in FIG. 3A.

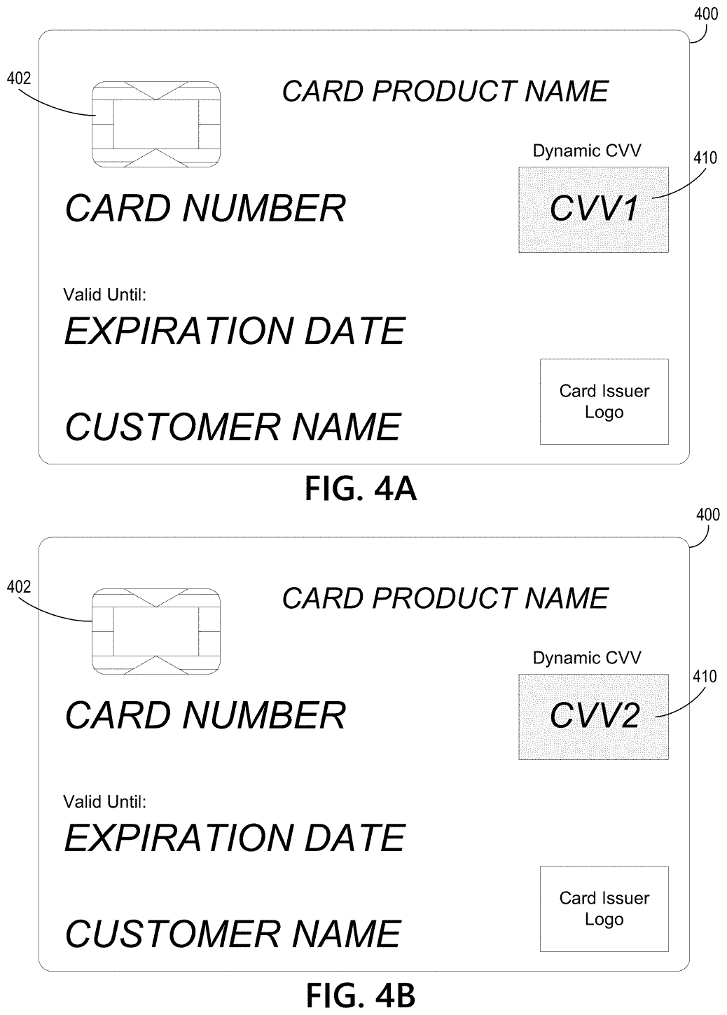

FIGS. 4A and 4B depict illustrative front side views of a card 400 with an electronic ink display (e.g., electronic ink display 410) for displaying a dynamic CVV. As depicted in FIG. 4A, electronic ink display 410 may display a first CVV. When card 400 is used at a point-of-sale terminal or automated teller machine, card 400 may draw power (e.g., via integrated circuit 402) from the point-of-sale terminal or automated teller machine, and use the power to generate a new dynamic CVV and refresh electronic ink display 410. Thus, as depicted in FIG. 4B, electronic ink display 410 may display a second CVV that is different from the first CVV that electronic ink display 410 displayed in FIG. 4A.

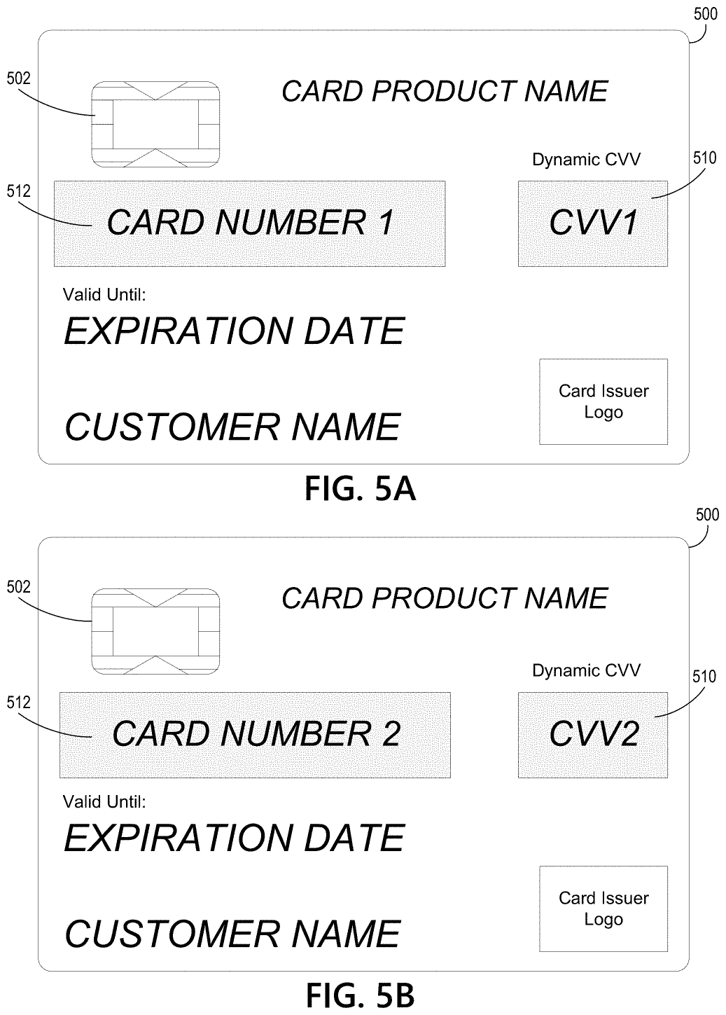

FIGS. 5A and 5B depict illustrative front side views of a card 500 with multiple electronic ink displays (e.g., electronic ink display 510, electronic ink display 512). A first electronic ink display (e.g., electronic ink display 510) may display a dynamic CVV. A second electronic ink display (e.g., electronic ink display 512) may display a card number. As depicted in FIG. 5A, electronic ink display 510 may display a first CVV, and electronic ink display 512 may display a first card number. When card 500 is used at a point-of-sale terminal or automated teller machine, card 500 may draw power (e.g., via integrated circuit 502) from the point-of-sale terminal or automated teller machine, and use the power to generate a new dynamic CVV and/or a new card number. Card 500 may use the power to refresh electronic ink display 510 and/or electronic ink display 512. Thus, as depicted in FIG. 5B, electronic ink display 510 may display a second CVV that is different from the first CVV that electronic ink display 510 displayed in FIG. 5A. Similarly, as depicted in FIG. 5B, electronic ink display 512 may display a second card number that is different from the first card number that electronic ink display 512 displayed in FIG. 5A.

In some instances, card 500 might not refresh any or all of its electronic ink displays every time card 500 is used at a point-of-sale terminal or automated teller machine, and may instead refresh none or a subset of its electronic ink displays. For example, a card number might not change every time card 500 is used, but a dynamic CVV may change every time card 500 is used. Some electronic ink displays may be configured to display information generated by card 500 (e.g., a dynamic CVV), while other electronic ink displays may be configured to display information received via a point-of-sale terminal or automated teller machine (e.g., a card number). Some electronic ink displays may be configured to update displayed information only when connected to a particular type of terminal (e.g., update when connected to an automated teller machine but not when connected to a point-of-sale terminal; update when connected to a point-of-sale terminal but not when connected to an automated teller machine; update when connected to a first type of point-of-sale terminal but not when connected to a second type of point-of-sale terminal).

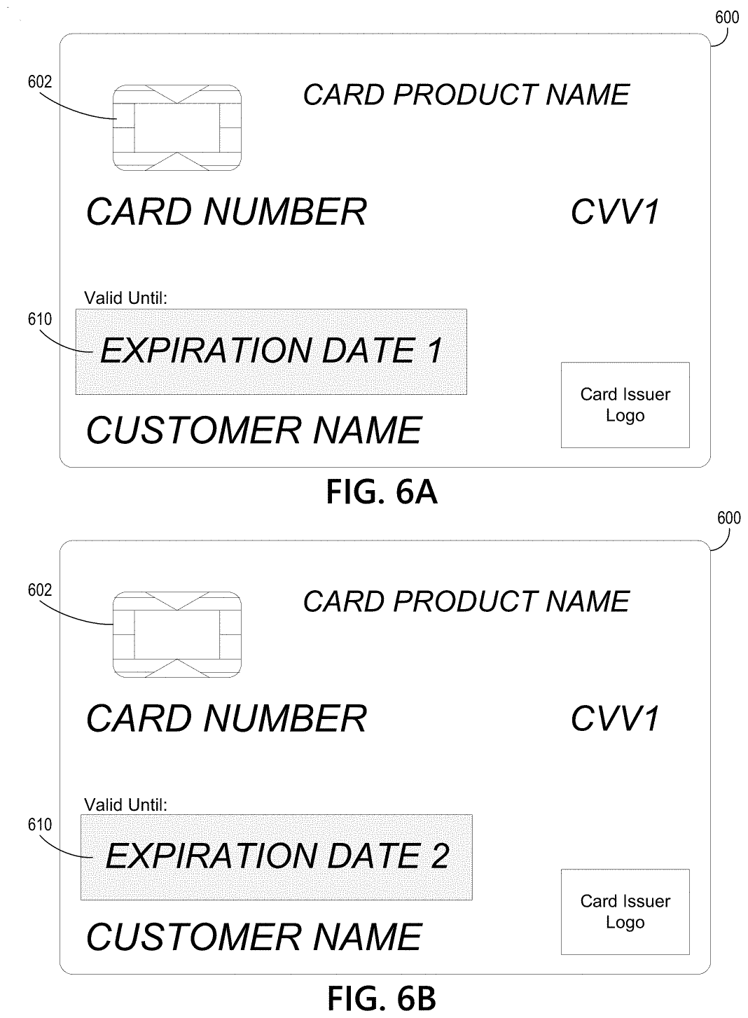

FIGS. 6A and 6B depict illustrative front side views of a card 600 with an electronic ink display (e.g., electronic ink display 610) for displaying an expiration date. As depicted in FIG. 6A, electronic ink display 610 may display a first expiration date. When card 600 is used at a point-of-sale terminal or automated teller machine, card 600 may draw power (e.g., via integrated circuit 602) from the point-of-sale terminal or automated teller machine, and use the power to generate a new expiration date and refresh electronic ink display 610. Thus, as depicted in FIG. 6B, electronic ink display 610 may display a second expiration date that is different from the first expiration date that electronic ink display 610 displayed in FIG. 6A.

In some instances, card 600 might not refresh the expiration date every time card 600 is used at a point-of-sale terminal or automated teller machine. For example, card 600 might only refresh the expiration date according to a time schedule (e.g., once a month, once a year, once every two years). In some embodiments, card 600 might refresh the expiration date based on a signal received from a remote device (e.g., a card issuer of card 600) via the point-of-sale terminal or automated teller machine. The signal from the remote device may include a new expiration date, or the signal may instruct card 600 to generate a new expiration date.

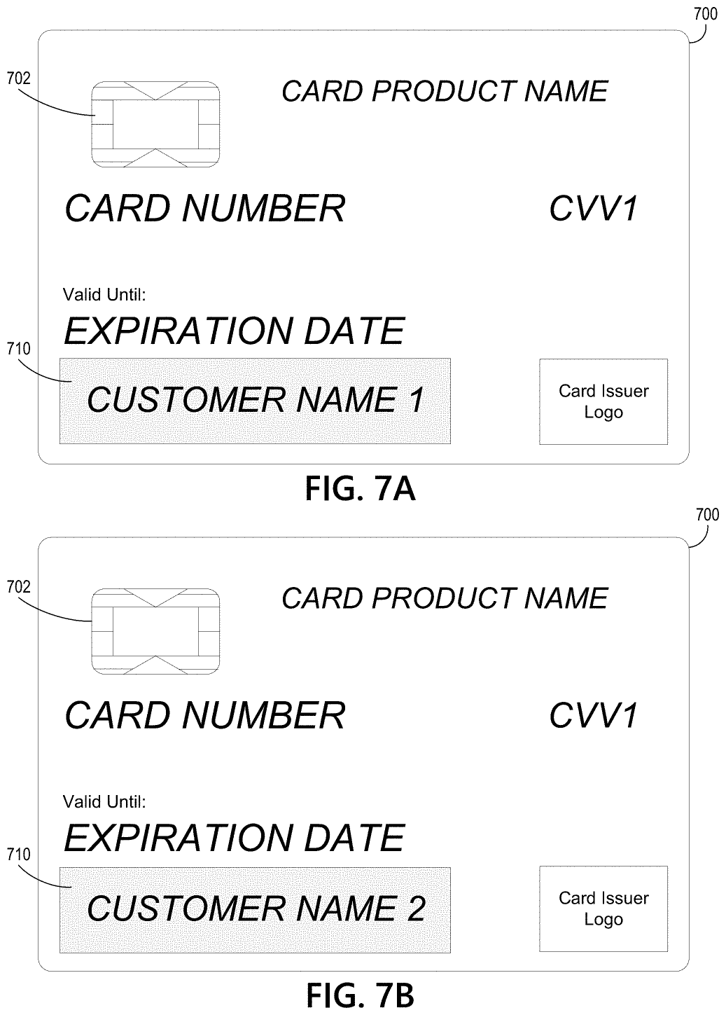

FIGS. 7A and 7B depict illustrative front side views of a card 700 with an electronic ink display (e.g., electronic ink display 710) for displaying a name (e.g., a customer name). As depicted in FIG. 7A, electronic ink display 710 may display a name. When card 700 is used at a point-of-sale terminal or automated teller machine, card 700 may draw power (e.g., via integrated circuit 702) from the point-of-sale terminal or automated teller machine, and use the power to update the name and refresh electronic ink display 710. Thus, as depicted in FIG. 7B, electronic ink display 710 may display a second name that is different from the first name that electronic ink display 710 displayed in FIG. 7A. For example, if a customer changes a name (e.g., due to marriage, divorce, witness-protection program, identity change, legal name change, or the like), electronic ink display 710 may be refreshed to display a new name. This may help the customer avoid the hassle of obtaining a new card after changing a name.

In some instances, card 700 might not change the name every time card 700 is used at a point-of-sale terminal or automated teller machine. For example, card 700 might only change the name based on a signal received from a remote device (e.g., a card issuer of card 700) via the point-of-sale terminal or automated teller machine. The signal from the remote device may include a new name for electronic ink display 710 to display. Electronic ink display 710 may refresh and display the new name received in the signal.

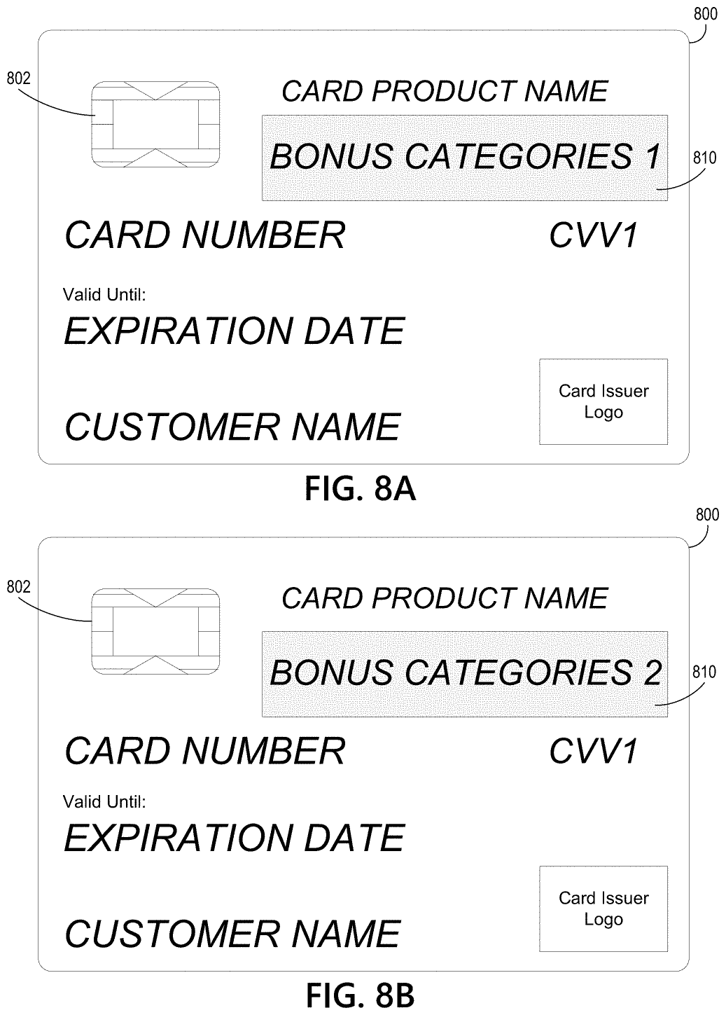

FIGS. 8A and 8B depict illustrative front side views of a card 800 with an electronic ink display (e.g., electronic ink display 810) for displaying one or more offers. For example, some cards may include bonus categories for which a customer may receive bonus points when spending with the card. Some cards rotate the bonus categories on a set basis (e.g., monthly, quarterly, annually), while other cards sometimes change the bonus categories on an irregular basis. Alternatively or additionally, some cards occasionally have special offers associated with spending on the cards, such as introductory sign-up offers, special promotional bonus categories or interest rates, special promotional offers for spending at a particular merchant or on a particular product, or the like. By displaying the one or more offers, electronic ink display 810 may make it easy for a customer to determine when it would be especially advantageous to use card 800 for spending in a particular category, at a particular merchant, on a particular product, or the like.

As depicted in FIG. 8A, electronic ink display 810 may display one or more offers, such as bonus categories. When card 800 is used at a point-of-sale terminal or automated teller machine, card 800 may draw power (e.g., via integrated circuit 802) from the point-of-sale terminal or automated teller machine, and use the power to update the one or more offers, such as bonus categories, and refresh electronic ink display 810. Thus, as depicted in FIG. 8B, electronic ink display 810 may display second one or more offers, such as bonus categories, that are different from the one or more offers that electronic ink display 810 displayed in FIG. 8A. For example, if card 800 has rotating quarterly bonus categories, then the rotating quarterly bonus categories may be updated to display the current quarter's bonus categories for spending on card 800. This may help the customer remember what the current quarter's bonus categories are for spending on card 800.

In some instances, card 800 might not change the displayed one or more offers every time card 800 is used at a point-of-sale terminal or automated teller machine. For example, card 800 might only change the displayed one or more offers based on a signal received from a remote device (e.g., a card issuer of card 800) via the point-of-sale terminal or automated teller machine. The signal from the remote device may include new offers, such as new bonus categories, for electronic ink display 810 to display. Electronic ink display 810 may refresh and display the new offers received in the signal.

In some instances, card 800 may display a customer's progress toward completing one or more offers, and may update the customer's progress every time card 800 is used. For example, if an offer requires a customer to make a certain number of purchases in a period of time (e.g., twenty purchases in a month), then every time card 800 is used at a point-of-sale terminal or automated teller machine, electronic ink display 810 may be refreshed to show the customer's progress toward completing that offer (e.g., the number of purchases the customer has made so far that month). In another example, if an offer requires the customer to spend a certain amount on the card in a period of time (e.g., $3000 in three months), then every time card 800 is used at a point-of-sale terminal or automated teller machine, electronic ink display 810 may be refreshed to show the customer's progress toward completing that offer (e.g., the amount the customer has spent on the card so far during the period of time of the offer). Thus, electronic ink display 810 may provide the customer a simple, convenient way to track progress toward offers on a particular card. A card issuer may benefit because a customer may be more inclined to use card 800 as a result of the customer having an easy reminder of the benefits of using card 800.

In another example, electronic ink display 810 may display a customer's rewards balance (e.g., a number of travel points or miles). Electronic ink display 810 may display a total rewards balance, a rewards amount earned on a most-recent statement, a rewards amount earned in the current year-to-date, and/or a rewards balance earned so far during a current statement period. Every time card 800 is used at a point-of-sale terminal or automated teller machine, electronic ink display 810 may be refreshed to show the customer's rewards progress.

In some embodiments, a customer may use an online profile to set what information to show on electronic ink display 810. An online server may receive one or more settings from a user device, updating a user profile, and then generate and/or send configuration commands to the card, via a point-of-sale terminal or automated teller machine. For example, if the customer would rather show rotating bonus categories instead of rewards earned so far in a statement period, the customer can set the profile accordingly. The next time card 800 is used at a point-of-sale terminal or automated teller machine, electronic ink display 810 may be refreshed to show information according to the customer's profile selection.

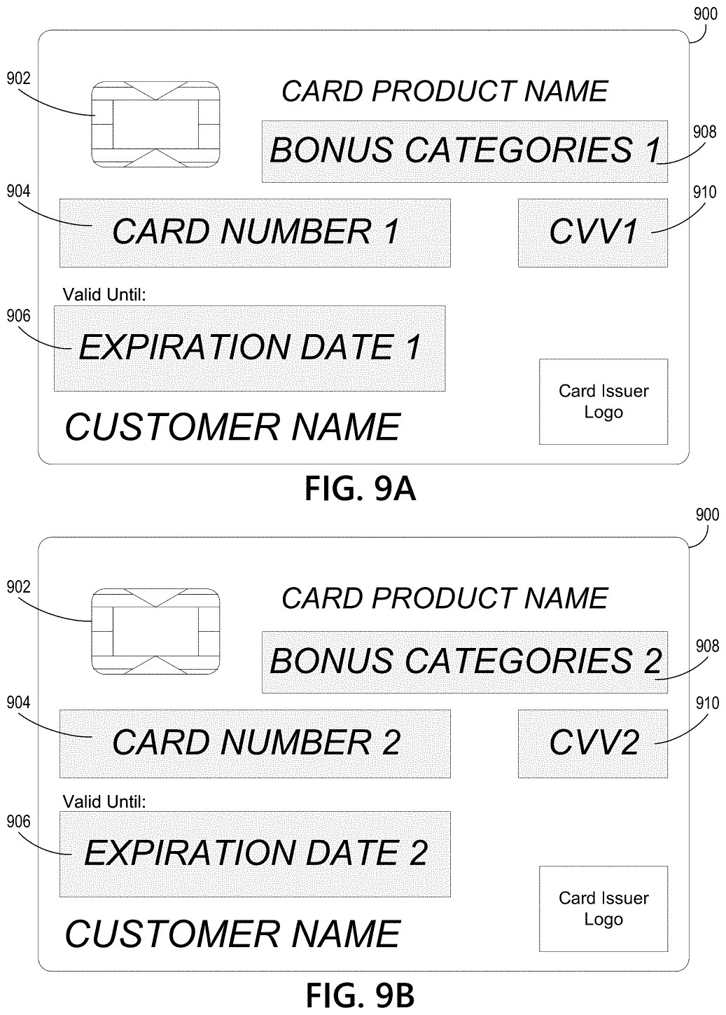

FIGS. 9A and 9B depict illustrative front side views of a card 900 with multiple electronic ink displays (e.g., electronic ink display 904, electronic ink display 906, electronic ink display 908, electronic ink display 910). A first electronic ink display (e.g., electronic ink display 904) may display a card number. A second electronic ink display (e.g., electronic ink display 906) may display an expiration date. A third electronic ink display (e.g., electronic ink display 908) may display one or more offers. A fourth electronic ink display (e.g., electronic ink display 910) may display dynamic CVV. As depicted in FIG. 9A, electronic ink display 904 may display a first card number, electronic ink display 906 may display a first expiration date, electronic ink display 908 may display first one or more offers, and/or electronic ink display 910 may display a first dynamic CVV. When card 900 is used at a point-of-sale terminal or automated teller machine, card 900 may draw power (e.g., via integrated circuit 902) from the point-of-sale terminal or automated teller machine, and use the power to generate a new dynamic CVV and/or other new information (e.g., new card number, new expiration date, new offers). Alternatively or additionally, card 900 may receive the new information via the point-of-sale terminal or automated teller machine. Card 900 may use the power to refresh electronic ink display 904, electronic ink display 906, electronic ink display 908, and/or electronic ink display 910. Thus, as depicted in FIG. 9B, electronic ink display 904 may display a second card number that is different from the first card number that electronic ink display 904 displayed in FIG. 9A. Similarly, electronic ink display 906 may display a second expiration date that is different from the first expiration date that electronic ink display 906 displayed in FIG. 9A. Similarly, electronic ink display 908 may display second offers that are different from the first offers that electronic ink display 908 displayed in FIG. 9A. Similarly, electronic ink display 910 may display a second CVV that is different from the first CVV that electronic ink display 910 displayed in FIG. 9A.

In some instances, card 900 might not refresh any or all of its electronic ink displays every time card 900 is used at a point-of-sale terminal or automated teller machine, and may instead refresh none or a subset of its electronic ink displays. For example, a card number, expiration date, and offers (such as bonus categories) might not change every time card 900 is used, but a dynamic CVV may change every time card 900 is used. Some electronic ink displays may be configured to display information generated by card 900 (e.g., a dynamic CVV), while other electronic ink displays may be configured to display information received via a point-of-sale terminal or automated teller machine (e.g., card number, expiration date, offers). Some electronic ink displays may be configured to update displayed information only when connected to a particular type of terminal (e.g., update when connected to an automated teller machine but not when connected to a point-of-sale terminal; update when connected to a point-of-sale terminal but not when connected to an automated teller machine; update when connected to a first type of point-of-sale terminal but not when connected to a second type of point-of-sale terminal).

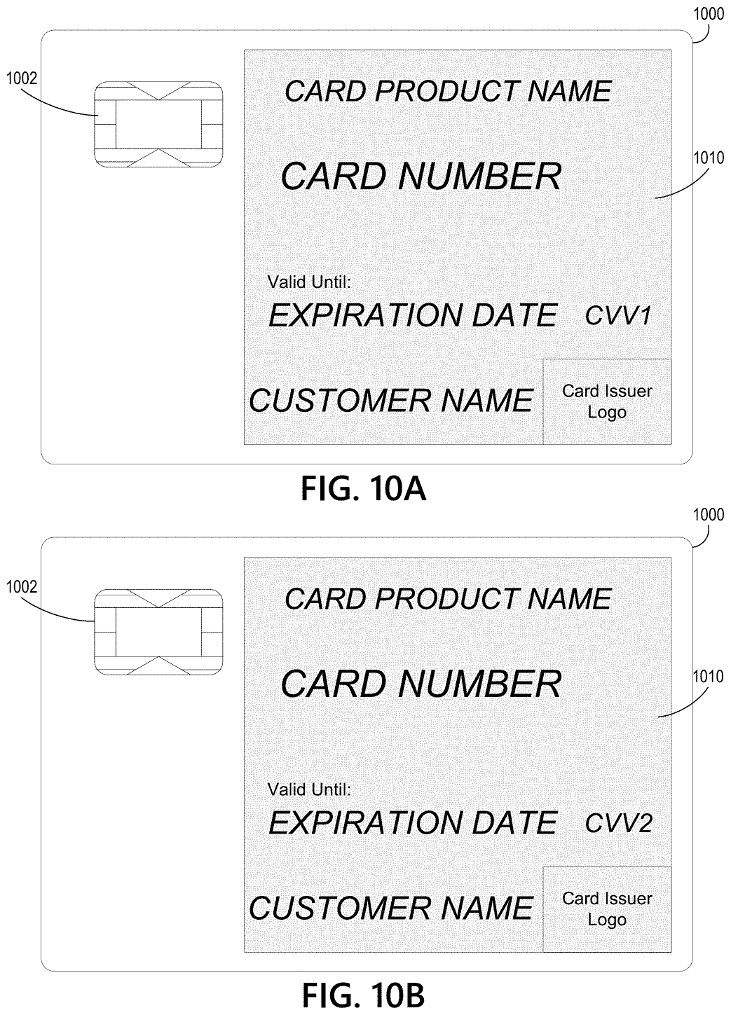

FIGS. 10A and 10B depict illustrative front side views of a card 1000 with an electronic ink display (e.g., electronic ink display 1010) that is configured to show multiple pieces of information about card 1000. For example, electronic ink display 1010 may be configured to display a card product name, a card number, an expiration date, a dynamic CVV, a customer name, a card issuer logo, and/or the like.

As depicted in FIG. 10A, electronic ink display 1010 may display a card product name, a card number, an expiration date, a first dynamic CVV, a customer name, and a card issuer logo. When card 1000 is used at a point-of-sale terminal or automated teller machine, card 1000 may draw power (e.g., via integrated circuit 1002) from the point-of-sale terminal or automated teller machine, and use the power to generate a new dynamic CVV and/or other new information (e.g., new card number, new expiration date, new offers). Alternatively or additionally, card 1000 may receive the new information via the point-of-sale terminal or automated teller machine. Card 1000 may use the power to refresh electronic ink display 1010. Thus, as depicted in FIG. 10B, electronic ink display 1010 may display a second dynamic CVV that is different from the first dynamic CVV that electronic ink display 1010 displayed in FIG. 10A.

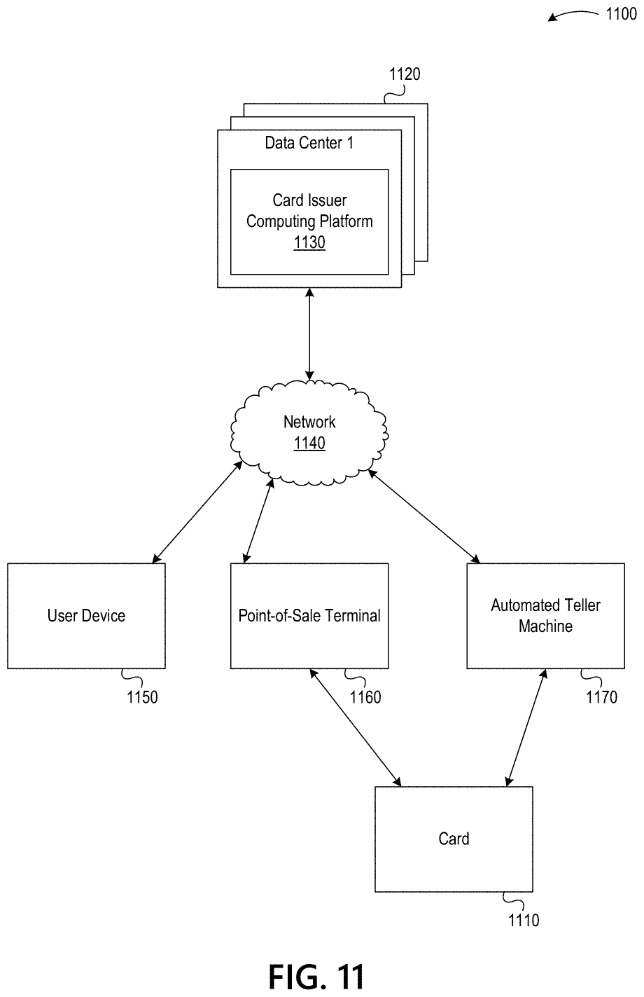

FIG. 11 depicts an illustrative computing environment 1100 for using a card 1110 with one or more electronic ink displays for displaying dynamic information. Computing environment 1100 may include one or more data centers and one or more computing devices, including computing devices located at or within such data centers and computing devices not located at or within such data centers. For example, computing environment 1100 may include a first data center 1120. Data center 1120 may include a card issuer computing platform 1130. Computing environment 1100 also may include a user device 1150, a point-of-sale terminal 1160, and/or an automated teller machine 1170.

Data center 1120 may be a distinct and physically separate data center operated by and/or otherwise associated with an organization, such as a financial institution. In addition, data center 1120 may house a plurality of server computers and various other computers, network components, and devices.

Card issuer computing platform 1130 may be configured to provide one or more portal interfaces to one or more client devices and/or may be configured to authenticate one or more client devices and/or users of such devices to such portal interfaces. For example, card issuer platform 1130 may be configured to provide a customer portal, such as an online banking portal, to one or more customers of an organization, such as a financial institution, who may use one or more client computing devices to access the portal and/or who may be authenticated to one or more portal user accounts by card issuer computing platform 1130 using various authentication techniques. In some instances, in addition to being configured to provide an online banking portal associated with a financial institution to one or more customers of the financial institution and/or their associated computing devices, card issuer computing platform 1130 also may be configured to provide a mobile banking portal associated with the financial institution to various customers of the financial institution and/or their associated mobile computing devices. Such portals may, for instance, provide customers of the financial institution with access to financial account information (e.g., account balance information, account statements, recent transaction history information, or the like) and/or may provide customers of the financial institution with menus, controls, and/or other options to schedule and/or execute various transactions (e.g., online bill pay transactions, person-to-person funds transfer transactions, or the like). Card issuer device 1130 may be configured to provide one or more interfaces that allow for configuration and management of one or more cards, computing devices, and/or computer systems included in computing environment 1100.

In some instances, data center 1120 may include one or more client account servers, which may be configured to store and/or maintain information associated with one or more client accounts. For example, the client account server(s) may be configured to store and/or maintain information associated with one or more financial accounts associated with one or more customers of a financial institution, such as account balance information, transaction history information, and/or the like. Additionally or alternatively, the client account server(s) may include and/or integrate with one or more client support servers and/or devices, such as one or more customer service representative devices used by one or more customer service representatives of an organization (which may, e.g., be a financial institution operating data center 1120), to connect one or more customers of the organization with one or more customer service representatives of the organization via one or more telephone support sessions, chat support sessions, and/or other client support sessions.

In one or more arrangements, user device 1150 may be any type of computing device capable of receiving a user interface, receiving input via the user interface, and communicating the received input to one or more other computing devices. For example, user device 1150 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, user device 1150 may, in some instances, be one or more special-purpose computing devices configured to perform specific functions.

Computing environment 1100 also may include one or more computing platforms. For example, computing environment 1100 may include card issuer computing platform 1130. As illustrated in greater detail below, card issuer computing platform 1130 may include one or more computing devices configured to perform one or more of the functions described herein. For example, card issuer computing platform 1130 may include one or more computers (e.g., laptop computers, desktop computers, servers, server blades, or the like). Computing environment 1100 also may include one or more networks, which may interconnect one or more of card issuer computing platform 1130, user device 1150, point-of-sale terminal 1160, and/or automated teller machine 1170. For example, computing environment 1100 may include network 1140, which may include one or more public networks, one or more private networks, and/or one or more sub-networks (e.g., local area networks (LANs), wide area networks (WANs), or the like).

Computing environment 1100 also may include one or more card interface devices, such as point-of-sale terminal 1160 and/or automated teller machine 1170. Point-of-sale terminal 1160 and/or automated teller machine 1170 may include a card-reading interface, such as an EMV chip interface, a magnetic strip reader, and/or a contactless reader (e.g., near-field communication (NFC), radio-frequency identification (RFID)). The one or more card interface devices, such as point-of-sale terminal 1160 and/or automated teller machine 1170, are connected to a power source. The one or more card interface devices, such as point-of-sale terminal 1160 and/or automated teller machine 1170, may be configured to send information to and receive information from card issuer computing platform 1130. This may include, for example, card authentication information, purchase information, and/or card update information (e.g., updated card number, expiration date, name, offers, or the like for display on one or more electronic ink displays of a connected card).

Computing environment 1100 also may include one or more cards (e.g., credit cards, debit cards, automated teller machine cards) with one or more electronic ink displays, such as, for example, card 1110. When card 1110 is inserted into an interface device (such as an EMV reader of point-of-sale terminal 1160 or automated teller machine 1170), the contacts on the integrated circuit (e.g., EMV chip) of card 1110 make contact with the connectors on the interface device. The interface device, which has a power source, supplies power to the integrated circuit of card 1110 and reads the data embedded in the integrated circuit.

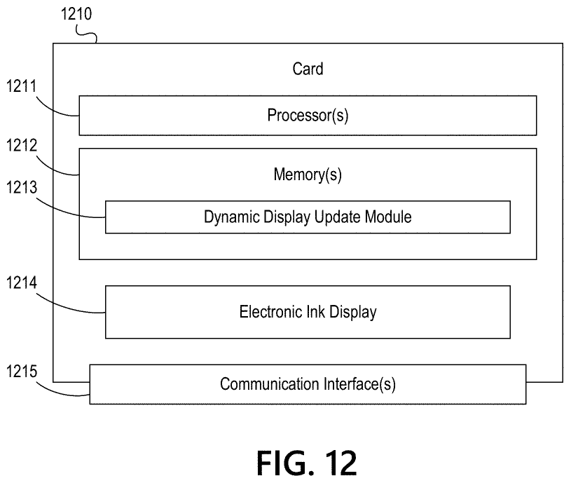

Referring to FIG. 12, card 1210 may include one or more processors 1211, memory 1212, electronic ink display 1214, and communication interface 1215. A data bus may interconnect processors 1211, memory 1212, electronic ink display 1214, and communication interface 1215. Communication interface 1215 may be a chip (e.g., an EMV chip) configured to support communication between card 1210 and an interface device (e.g., an EMV chip reader of a point-of-sale terminal or automated teller machine). The chip of communication interface 1215 may be configured to draw power (e.g., electrical current) from the interface device when connected to the interface device. Memory 1212 may include one or more program modules having instructions that when executed by processor 1211 cause card 1210 to perform one or more functions described herein. In some instances, the one or more program modules may be stored by and/or maintained in different memory units of card 1210. In some instances, the one or more program modules may be instantiated in custom chips or integrated circuits, such as a custom chip configured to perform set pre-programmed logic. Memory 1212 may have, store, and/or include a dynamic display update module 1213. Dynamic display update module 1213 may have instructions that direct and/or cause card 1210 to generate a new dynamic CVV code, generate new other information, and/or to receive information via communication interface 1215. Dynamic display update module 1213 may also have instructions that direct and/or cause card 1210 to refresh electronic ink display 1214 to display updated information.

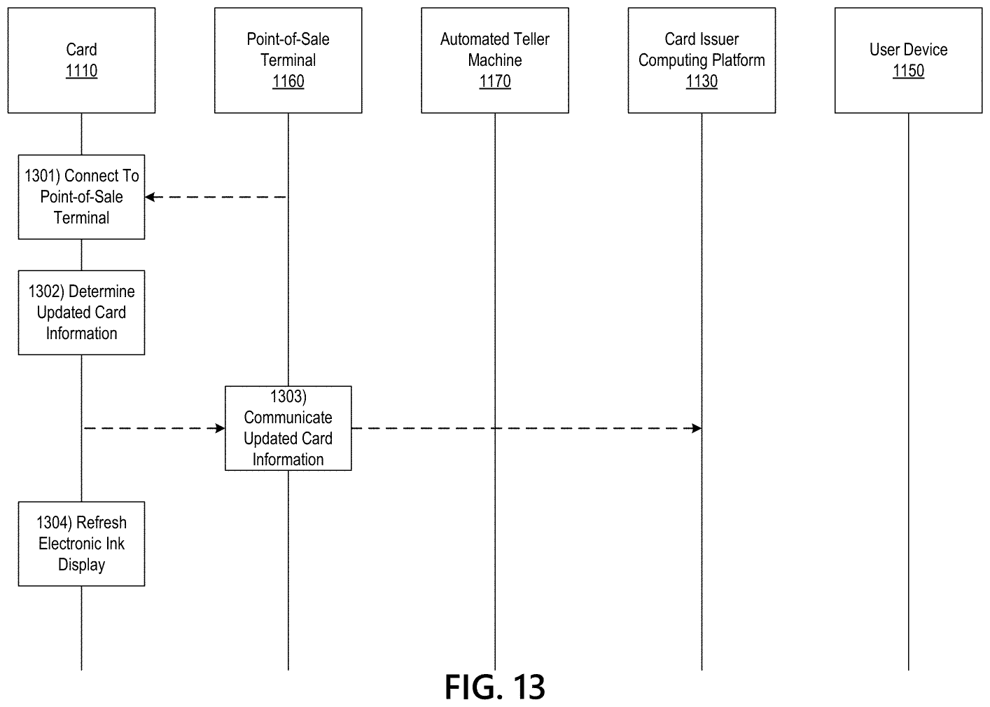

FIG. 13 depicts an illustrative event sequence for displaying dynamic card information on an electronic ink display in accordance with one or more example embodiments. At step 1301, card 1110 may connect to a point-of-sale terminal 1160, for example by being inserted into point-of-sale terminal 1160 (and an EMV chip of card 1110 connecting to an EMV reader of point-of-sale terminal 1160) or coming into an electromagnetic field generated by point-of-sale terminal 1160. Card 1110 may draw power from point-of-sale terminal 1160 when connected to point-of-sale terminal 1160. At step 1302, card 1110 may determine updated card information, such as a new dynamic CVV. At step 1303, card 1110 may communicate updated card information (e.g., the new dynamic CVV) to point-of-sale terminal 1160, which may communicate the updated card information (e.g., the new dynamic CVV) to card issuer computing platform 1130. At step 1304, card 1110 may refresh an electronic ink display of card 1110, so as to display the updated card information (e.g., the new dynamic CVV).

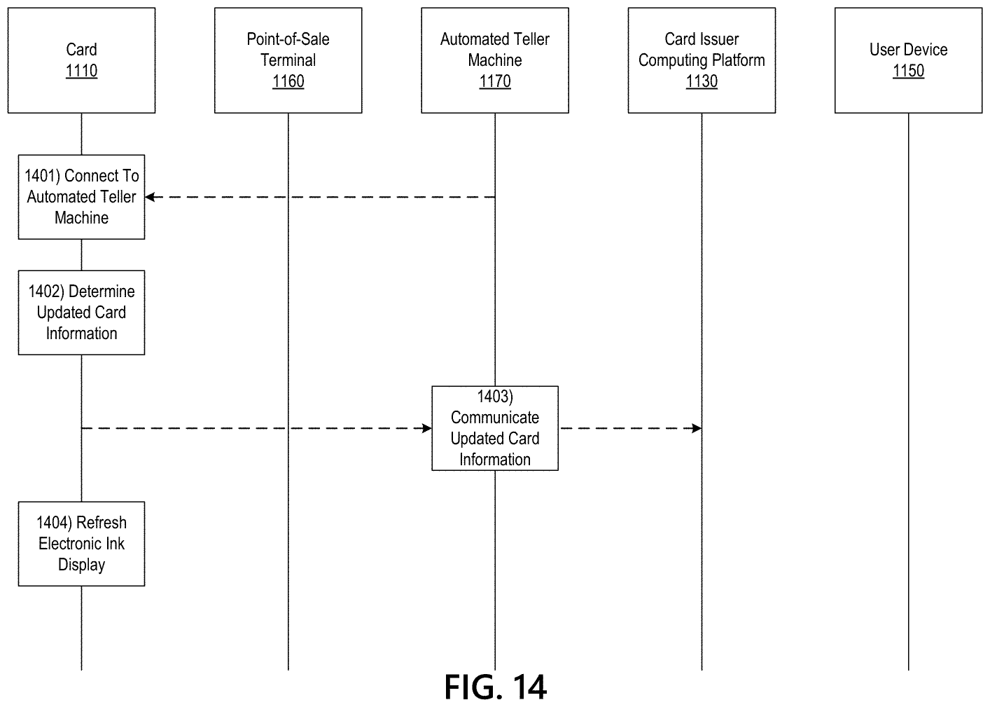

FIG. 14 depicts an illustrative event sequence for displaying dynamic card information on an electronic ink display in accordance with one or more example embodiments. At step 1401, card 1110 may connect to an automated teller machine 1170, for example by being inserted into automated teller machine 1170 (and an EMV chip of card 1110 connecting to an EMV reader of automated teller machine 1170) or coming into an electromagnetic field generated by automated teller machine 1170. Card 1110 may draw power from automated teller machine 1170 when connected to automated teller machine 1170. At step 1402, card 1110 may determine updated card information, such as a new dynamic CVV. At step 1403, card 1110 may communicate updated card information (e.g., the new dynamic CVV) to automated teller machine 1170, which may communicate the updated card information (e.g., the new dynamic CVV) to card issuer computing platform 1130. At step 1404, card 1110 may refresh an electronic ink display of card 1110, so as to display the updated card information (e.g., the new dynamic CVV).

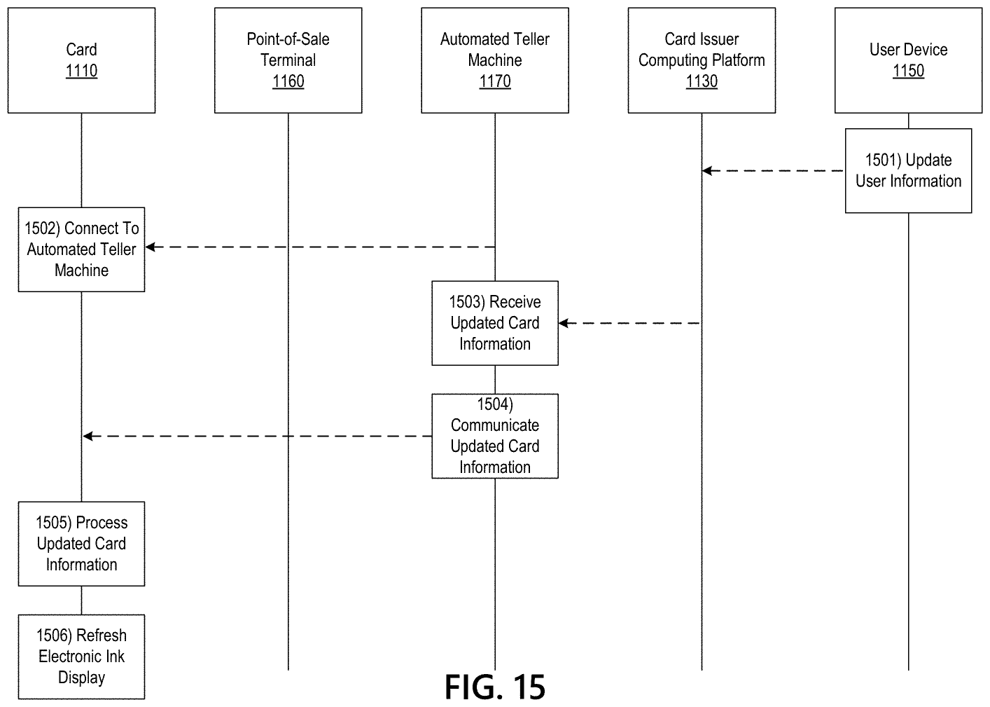

FIG. 15 depicts an illustrative event sequence for displaying dynamic card information on an electronic ink display in accordance with one or more example embodiments. At step 1501, user device 1150 may provide updated user information to a card issuer (e.g., user device may communicate a user profile update to a computer associated with the card issuer, such as card issuer computing platform 1130). For example, as depicted in FIG. 17, a graphical user interface 1700 may be used (e.g., via user device 1150) to provide updated user information, such as an updated customer name, a rewards profile number, or the like. Returning to FIG. 15, at step 1502, card 1110 may connect to an automated teller machine 1170, for example by being inserted into automated teller machine 1170 (and an EMV chip of card 1110 connecting to an EMV reader of automated teller machine 1170) or coming into an electromagnetic field generated by automated teller machine 1170. Card 1110 may draw power from automated teller machine 1170 when connected to automated teller machine 1170. At step 1503, automated teller machine 1170 may receive the updated user information from card issuer computing platform 1130. At step 1504, automated teller machine 1170 may communicate the updated card information to card 1110 (e.g., via EMV chip of card 1110). At step 1505, card 1110 may process the updated card information received via automated teller machine 1170. For example, card 1110 may update a memory storing card information to store the updated card information. At step 1506, card 1110 may refresh an electronic ink display of card 1110, so as to display the updated card information (e.g., updated customer name, a rewards profile number).

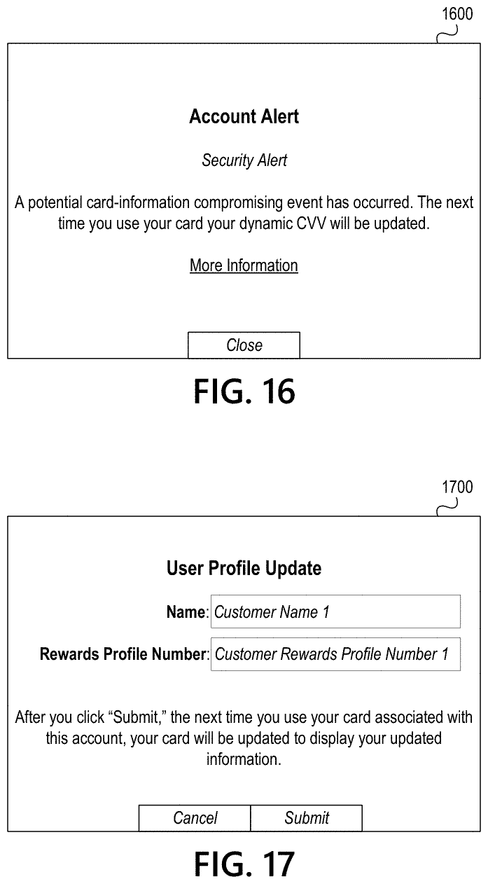

Referring to FIG. 16, in some embodiments, card issuer computing platform 1130 may be configured to detect alert parameters based on events related to card 1110. For example, if a card compromising event has occurred (e.g., a merchant at which card 1110 was used in the past has been compromised, and card information of card 1110 was potentially compromised in the merchant breach), then card issuer computing platform 1130 may trigger one or more alerts to be sent to one or more computing devices associated with an owner of card 1110.

In some instances, such an alert may direct and/or otherwise cause a computing device, such as user device 1150, to display and/or otherwise present a graphical user interface similar to graphical user interface 1600, which is illustrated in FIG. 16. As seen in FIG. 16, graphical user interface 1600 may include information notifying an owner of card 1110 that an alert has been received by user device 1150, and that the next time card 1110 is used (e.g., at a point-of-sale terminal or automated teller machine), a dynamic CVV code, card number, expiration date, or other card information will be updated. Thus, the owner of card 1110 may easily be reassured about the security of the account associated with card 1110, and avoid the hassle of replacing card 1110 in the event of a security breach associated with card 1110.

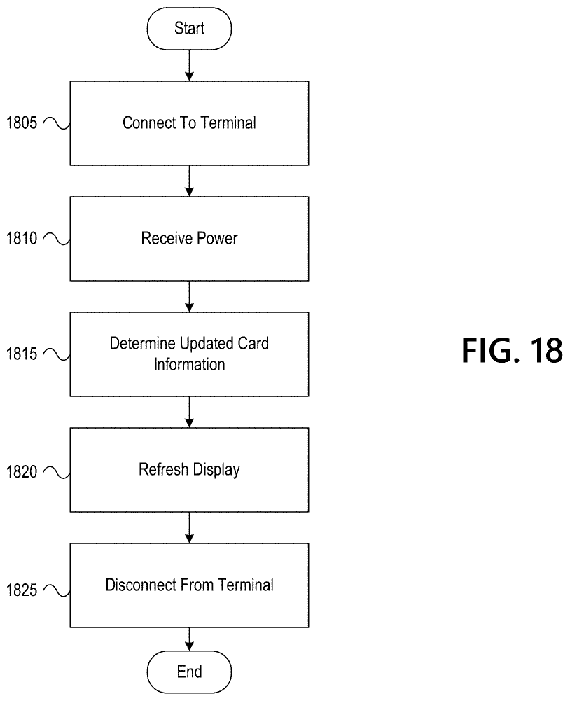

FIG. 18 depicts an illustrative method for updating card information on a card including an electronic ink display that does not have a built-in power source (such as a battery), in accordance with one or more example embodiments. Referring to FIG. 18, at step 1805, a card having an electronic ink display, an integrated circuit (e.g., an EMV chip), at least one processor, and memory may be connected to a terminal (e.g., a point-of-sale terminal or automated teller machine) with an integrated circuit interface device (e.g., an EMV reader, a contactless reader). At step 1810, the card may draw power (e.g., electrical current) to the card from the terminal (e.g., the point-of-sale terminal or automated teller machine) to which the card is connected via the integrated circuit. Using the power from the point-of-sale terminal or the automated teller machine to which the card is connected, the card may, at step 1815, update card information (e.g., update a dynamic card verification value for the card to a new dynamic card verification value), and at step 1820, refresh the electronic ink display to display the updated card information (e.g., the new dynamic card verification value). At step 1825, the card may disconnect from the terminal. In some embodiments, the card may disconnect from the terminal before determining the updated card information. In these instances, the card may use the power drawn from the terminal by storing the power in a capacitor or other device that enables the card to store enough power to perform steps 1815 and 1820.

In some instances, a card might not receive enough power from a terminal to update all the potential card information that could be updated and/or to refresh all the electronic ink displays that could be refreshed (e.g., if the card has multiple electronic ink displays). The card might determine whether the card has enough power (e.g., stored in a capacitor on the card) to perform an update of the card information and a refresh of the electronic ink display. If the card does not have enough power to perform the update of the card information and/or the refresh of the electronic ink display, the card might not perform the update of the card information and/or the refresh of the electronic ink display.

In some instances, a point-of-sale terminal might not indicate that a user should “remove card” until the card is done updating the card information and refreshing the electronic ink display(s) of the card. For example, the terminal might wait to receive a confirmation from the card indicating that the card information has been updated and the electronic ink display(s) of the card has/have been refreshed. Because point-of-sale terminal transactions are usually not instant, the user is unlikely to notice a degraded purchase experience if the point-of-sale terminal is slightly delayed due to waiting for a card to finish refreshing the electronic ink display(s) of the card. In many instances, the card may update the card information and refresh the electronic ink display(s) of the card in parallel with transaction authentication communications, and the card may update the card information and refresh the electronic ink display(s) of the card faster than the transaction authentication communications are finished, in which case the transaction will not be delayed by the card updating the card information and refreshing the electronic ink display(s) of the card.

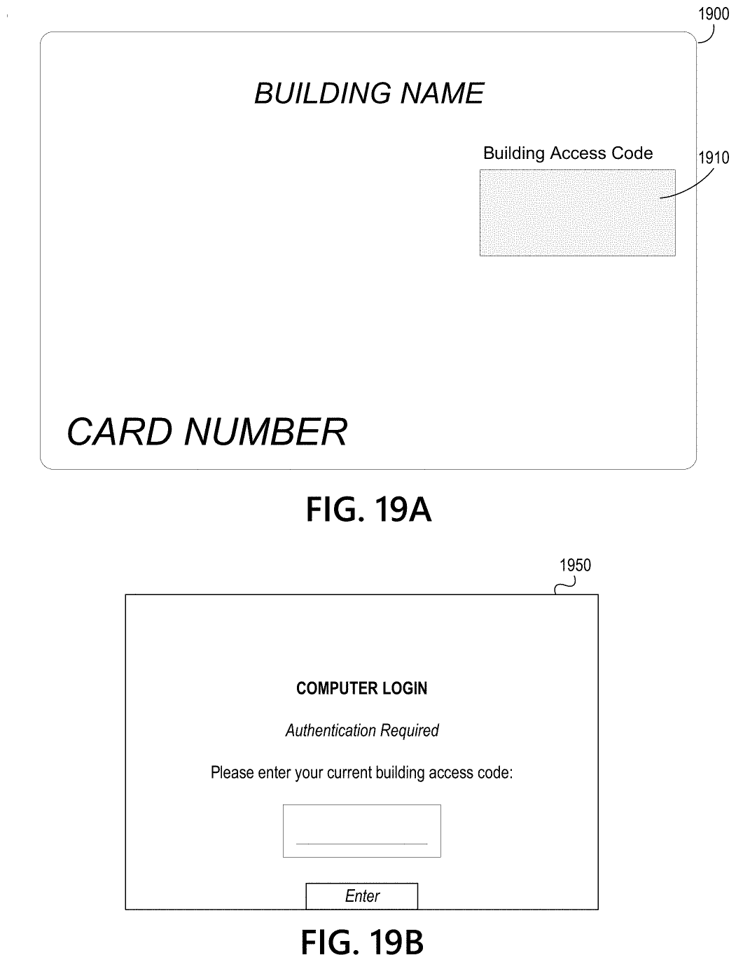

Referring to FIGS. 19A and 19B, the electronic ink display described herein may be used in embodiments other than credit or debit cards. For example, as depicted in FIG. 19A, a card 1900 may include an electronic ink display 1910 that displays a building access code. For some buildings, work places, facilities, or the like, information security may be enhanced by requiring a physical presence within a building to access information. For example, a secure compartmented information facility (SCIF) is a facility with particular information security enhancements designed to allow sensitive information to be accessed within but only within the facility. In another example, some employers require employees to be at the office to access certain files, servers, teleconferences, or the like.

In some embodiments, a building may have an associated dynamic building access code that is required for use to access particular information (e.g., information that should only be accessed while in the building). When arriving to the building, card 1900 may be scanned (e.g., contactless), inserted into an interface device (e.g., contact pins), or otherwise authenticated. When connecting to the authentication device, card 1900 may draw power from the interface device, and use the power to update the dynamic security code and refresh electronic ink display 1910 that displays the current building security code. Card 1900 may include a built-in dynamic building security code generator (e.g., similar to a smart card, hardware token, key fob, or the like), or card 1900 may receive an updated building security code via the interface device while connected to the interface device.

In some instances, a user may be required to scan in to enter a building and to scan out to exit the building. In some embodiments, card 1910 may refresh electronic ink display 1910 to erase the current building security code when the user scans out to exit the building, which may help ensure that the user does not use the current building security code after exiting the building.

Referring to FIG. 19B, a graphical user interface 1950 may receive entry of a current building security code to access information. The user may enter the updated building security code displayed on electronic ink display 1910 into graphical user interface 1950 in order to access information. Since the user had to authenticate to enter the building, and received the updated building security code when entering the building, card 1900 can be used to ensure that the user only accesses the secure information while physically located within the building.

In another example of an embodiment where a card could include an electronic ink display, a vehicle may have an associated key shaped like a traditional credit or debit card. This allows for conveniently carrying an automobile key in a wallet or purse, without having to deal with the hassle of a bulky vehicle key that would otherwise bulge in a pocket or take up a lot of space in a purse. The automobile key card may include one or more electronic ink displays that could display, for example, a user PIN that allows for authentication of an individual driver. In another example, electronic ink display could include vehicle security information, such as a radio programming code. When the automobile key card is connected to the vehicle, the key card could use the power from the automobile to update the card information and refresh the electronic ink display.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A card comprising:
an electronic ink display;
an integrated circuit configured to connect to and draw power from a point-of-sale terminal or an automated teller machine;
at least one processor; and
memory storing computer-readable instructions that, when executed by the at least one processor, cause the card to:
determine that the card has connected, via the integrated circuit, to the point-of-sale terminal or the automated teller machine;
update a dynamic card verification value for the card to a new dynamic card verification value; and
refresh the electronic ink display to display the new dynamic card verification value.

2. The card of claim 1, wherein the processor uses the power from the point-of-sale terminal or the automated teller machine to execute the computer-readable instructions.

3. The card of claim 1, wherein the card uses the power from the point-of-sale terminal or the automated teller machine to refresh the electronic ink display.

4. The card of claim 1, wherein the computer-readable instructions, when executed by the at least one processor, cause the card to:
receive, via the point-of-sale terminal or the automated teller machine, new information for display on the electronic ink display of the card; and
refresh the electronic ink display of the card to display the new information.

5. The card of claim 4, wherein the computer-readable instructions, when executed by the at least one processor, cause the card to:
receive an updated card number for the card; and
refresh the electronic ink display of the card to display the updated card number for the card.

6. The card of claim 4, wherein the computer-readable instructions, when executed by the at least one processor, cause the card to:
receive an updated expiration date for the card; and
refresh the electronic ink display of the card to display the updated expiration date for the card.

7. The card of claim 4, wherein the computer-readable instructions, when executed by the at least one processor, cause the card to:
receive an updated name of a person associated with the card; and
refresh the electronic ink display of the card to display the updated name of the person associated with the card.

8. The card of claim 4, wherein the computer-readable instructions, when executed by the at least one processor, cause the card to:
receive an updated offer associated with the card; and
refresh the electronic ink display of the card to display the updated offer associated with the card.

9. The card of claim 1, wherein the integrated circuit comprises an EMV chip.

10. The card of claim 8, wherein the EMV chip is configured according to an International Organization for Standardization and International Electrotechnical Commission (ISO/IEC) 7816 standard.

11. The card of claim 1, wherein the electronic ink display displays a static image until the electronic ink display is refreshed.

12. The card of claim 11, wherein the electronic ink display does not require power to display the static image until the electronic ink display is refreshed.

13. The card of claim 1, wherein the electronic ink display is configured to display multiple pieces of information associated with the card.

14. The card of claim 1, comprising a second electronic ink display,
wherein the computer-readable instructions, when executed by the at least one processor, cause the card to:
refresh the second electronic ink display of the card to display updated information different from the new dynamic card verification value.

15. The card of claim 1, comprising a magnetic strip, the magnetic strip configured to draw second power from the point-of-sale terminal or the automated teller machine when the magnetic strip is in communication with the point-of-sale terminal or the automated teller machine.

16. The card of claim 1, comprising a contactless chip, the contactless chip configured to draw second power from the point-of-sale terminal or the automated teller machine when the magnetic strip is in communication with the point-of-sale terminal or the automated teller machine.

17. The card of claim 1, wherein the computer-readable instructions, when executed by the at least one processor, cause the card to:
receive a command, via the integrated circuit and from the point-of-sale terminal or the automated teller machine, indicating that the dynamic card verification value for the card should be updated to the new dynamic card verification value; and
based on the command, update the dynamic card verification value for the card to the new dynamic card verification value.

18. The card of claim 1, wherein a size of the card conforms to an International Organization for Standardization and International Electrotechnical Commission (ISO/IEC) 7810 ID-1 standard.

19. A method, comprising:
at a card comprising an electronic ink display, an integrated circuit, at least one processor, and memory:
draw power to the card from a point-of-sale terminal or an automated teller machine to which the card is connected via the integrated circuit; and
using the power from the point-of-sale terminal or the automated teller machine to which the card is connected:
update a dynamic card verification value for the card to a new dynamic card verification value; and
refresh the electronic ink display to display the new dynamic card verification value.

20. A system comprising:
an automated teller machine; and
a card comprising:
an electronic ink display;
an integrated circuit configured to draw power from the automated teller machine when the card is connected to the automated teller machine;
at least one processor; and
memory storing executable instructions that, when executed by the at least one processor using the power drawn from the automated teller machine, cause the card to:
update a dynamic card verification value for the card to a new dynamic card verification value; and
use the power drawn from the automated teller machine to refresh the electronic ink display to display the new dynamic card verification value.
